(19) United States
(12) Patent Application Publication
(10) Pub. No.: US 2006/0099000 A1
(43) Pub. Date: May 11, 2006

(54) Method and device for controlling the time at which the toner concentration is measured in a developer mixture containing toner and carriers, and corresponding printer or copier

(76) Inventors: Stefan Franzl, Toging (DE); Florian Kofferlein, Munchen (DE); Stefan Krieger, Buchbach (DE); Peter Mostl, Altdorf (DE); Alfred Zollner, Eitting (DE)

Correspondence Address: SCHIFF HARDIN, LLP;PATENT DEPARTMENT, 6600 SEARS TOWER, CHICAGO, IL, 60606-6473, US

(21) Appl. No.: 10/542,647

(22) PCT Filed: Feb. 6, 2004
(86) PCT No.: PCT/EP04/01114

§ 371 Date: Oct. 5, 2005

(30) Foreign Application Priority Data
Feb. 6, 2003 (DE) 103 04 884.7

(51) Int. Cl. G03G 15/10

(52) U.S. Cl. 399/58

(57) ABSTRACT

In a method or apparatus for control of a point in time of a measurement of toner concentration in a developer mixture comprising toner and carrier, and wherein the developer mixture is mixed by a bucket roller provided with buckets, a toner concentration sensor is arranged for measurement of the toner concentration. Magnet bars are provided on the buckets, which magnet bars are interrupted in a region of the toner concentration sensor except for one of the magnet bars which is uninterrupted. The toner concentration sensor emits a sensor signal that exhibits a first pulse-shaped spike upon passage of the uninterrupted magnet bar and which has a larger amplitude compared to further pulse-spikes of smaller amplitude upon passage of the interrupted magnet bars. The sensor signal indicates the toner concentration between the pulse-shaped spikes. A point in time of occurrence of the first pulse-shaped spike is determined in the sensor signal and a measurement is implemented of the toner concentration in a measurement window that lies after occurrence of the first pulse-shaped spike. Also in a method or apparatus for control of a point in time of a measurement of toner concentration in the developer mixture, a bucket roller with buckets is provided. A toner concentration sensor is arranged adjacent to the bucket roller which emits a sensor signal indicating toner concentration. Pulse-shaped spikes are exhibited in the sensor signal upon passage of the buckets and the sensor signal indicates toner concentration between the pulse-shaped spikes. A magnet is arranged on a shaft of the bucket roller and a Hall sensor is arranged adjacent to the magnet. Measurement of the toner concentration is implemented controlled by a trigger signal from the Hall sensor in a measurement window that lies in a region of the sensor signal that lies between the spikes caused by the buckets.

### BACKGROUND

Electrophotographic printers or copiers are known, see for example EP 0 653 077 B1. In these printers or copiers, charge images of images to be printed are generated on an intermediate carrier, for example a photoconductor drum. The charge images are inked with toner and the toner images are subsequently transfer-printed onto a recording medium, for example paper. For a fixed binding of the toner images with the recording medium, these are moved through a fixing station. The inking of the charge images on the intermediate carrier occurs in a developer station whose design is, for example, known from EP 0 857 324 B1. There a developer mixture comprising, for example, toner and carrier is stirred and subsequently directed onto the intermediate carrier via developer rollers, for example magnet brushes. Toner transfers onto the intermediate carrier corresponding to the charge images on the intermediate carrier. The developer mixture falls from the carrier and the remaining toner falls back into the developer station and there is supplemented with new toner.

The determination of the toner concentration in a developer mixture comprising toner and carrier is of importance in such an electrophotographic printer or copier. There, as described above, charge images of images to be printed are generated on the intermediate carrier. These charge images are inked with toner in the developer station. In order to obtain an acceptable print image, the toner concentration in the developer mixture comprised of toner and carrier must be adjustable. For this it is necessary that the toner concentration in the developer mixture be known.

An example of a part of such an electrophotographic printer or copier can be learned from DE 197 42 668 A1 or EP 0 563 077 B1, as shown in FIG. 1. Charge images of images to be printed are generated on a photoconductor drum 1. These charge images are inked with toner in a developer station 2. For this, in the developer station 2 a developer mixture is poured into the intake for toner 6, which developer mixture falls into a developer sump 4. The developer mixture is stirred in a mixing device 7, here by a bucket roller 3. The bucket roller 3 transports the developer mixture close to a developer roller 5/1 that takes up the developer mixture and moves it to a further developer roller 5/2. The developer rollers 5 develop the charge images on the photoconductor drum 1 in a known manner. The bucket roller 3 comprises buckets 8 that serve to transport the developer mixture. Since toner is drawn from the developer mixture via the development of the charge images, it is necessary to supply new toner. This occurs via the intake 6. In order to adjust the quantity of the toner to be supplied, the toner concentration in the developer mixture must therefore be determined.

The content of EP 0 653 077 B1, EP 857 324 B1, DE 197 668 A1 and their respective corresponding disclosures is herewith incorporated by reference into the present specification.

In US 2001/053 293 A1 and U.S. Pat. No. 6,212,341 B1 it is described how the toner concentration can be measured in a developer station. The developer is moved in one direction by an outer mixing screw with helices and in the opposite direction by an inner mixing screw. To measure the toner concentration, underneath the mixing screw a toner concentration sensor is arranged onto which the toner falls from the mixing screw and deposits there. The toner concentration sensor then measures the toner concentration at a point in time at which the toner deposit on the toner concentration sensor has reached a maximum. In order to enable a repeated measurement, a scraper is attached on the mixing screw that rotates with the mixing screw and abrades the toner from the toner concentration sensor. The sensor signal emitted by the sensor then has a minimum when the toner has been abraded from the sensor. This minimum is fixed and the measurement is implemented, derived from this, after a delay period.

An object is to specify a method and an arrangement via which the toner concentration in the developer mixture is measured with less effort and nevertheless reliably.

In a method or apparatus for control of a point in time of a measurement of toner concentration in a developer mixture comprising toner and carrier, the developer mixture is mixed by a bucket roller provided with buckets. A toner concentration sensor is arranged for measurement of the toner concentration in the developer mixture adjacent to the bucket roller. Magnet bars are provided on the buckets, which magnet bars are interrupted in a region of the toner concentration sensor except for one of the magnet bars which is uninterrupted in the region. The toner concentration sensor emits a sensor signal that exhibits a first pulse-shaped spike upon passage of the uninterrupted magnet bar and which has a larger amplitude compared to further pulse-spikes of smaller amplitude upon passage of the interrupted magnet bars. The sensor signal exhibits a value indicating the toner concentration between the pulse-shaped spikes. A point in time of occurrence of the first pulse-shaped spike is determined in the sensor signal and a measurement is implemented of the toner concentration in a measurement window that lies after occurrence of the first pulse-shaped spike.

Also in a method or apparatus for control of a point in time of a measurement of toner concentration in the developer mixture, a bucket roller with buckets is provided. A toner concentration sensor is arranged adjacent to the bucket roller and which emits a sensor signal indicating toner concentration in the developer mixture. Pulse-shaped spikes are exhibited in the sensor signal upon passage of the buckets and the sensor signal exhibits a value indicating toner concentration between the pulse-shaped spikes. A magnet is arranged on a shaft of the bucket roller and a Hall sensor is arranged adjacent to the magnet. Measurement of the toner concentration is implemented controlled by a trigger signal from the Hall sensor in a measurement window that lies in a region of the sensor signal that lies between the spikes caused by the buckets.

### BRIEF DESCRIPTION OF THE DRAWINGS

FIG. 1 illustrates a developer station known from DE 197 42 668 A1;

FIG. 2 shows the curve of the sensor signal in an arrangement without a Hall sensor;

FIG. 3 shows the curve of the sensor signal corresponding to FIG. 2 for the case that no pulse-shaped spike occurs during a revolution of the bucket roller;

FIG. 4 illustrates the curve of the sensor signal for the case that a Hall sensor is used to generate the trigger signal; and

FIG. 5 is a principle representation of the bucket roller.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

It is appropriate to arrange the toner concentration sensor in the mixing device and in fact adjacent to the bucket roller. The toner concentration is then measured at the point at which new toner is mixed into the developer mixture. The sensor signal emitted by the toner concentration sensor and indicating the toner concentration can be evaluated with regard to the toner concentration. For this it is necessary to establish the point in time of the measurement or a measurement window. Since a pulse-shaped spike (that is essentially caused by the bucket and not only by the toner concentration) occurs in the sensor signal upon a bucket of the bucket roller passing by the toner concentration sensor, it is advantageous when the measurement window is set in the time range between such pulse-shaped spikes in the sensor signal.

In order to correspondingly place the measurement window, it is necessary to determine the temporal position of the pulse-shaped spikes in the sensor signal. For this, it can be established that when the sensor signal exhibits its largest rise, this lies at a pulse-shaped spike. To establish the rise, the sensor signal can be sampled at the same temporal interval and the determined amplitude values can be examined as to whether they exceed a predetermined threshold. Or, the difference of successive amplitude values of the sensor signal can be generated and the difference with the largest value can be drawn upon to indicate the position of the pulse-shaped spike.

When the temporal position of one or more pulse-shaped spikes is determined in the sensor signal, the measurement window can be placed such that it comes to lie between two pulse-shaped spikes. In a simple manner, a delay period that must be added onto the point in time of the occurrence of a pulse-shaped spike in order to arrange the measurement window between two pulse-shaped spikes can be determined from the rotation speed of the bucket roller given knowledge of the position of the pulse-shaped spikes. Naturally, the points in time of the occurrence of the pulse-shaped spikes can also be determined and the measurement window correspondingly placed. A trigger signal that can be used to control the measurement window can be derived from the temporal position of at least one of the pulse-shaped spikes.

If magnet are arranged on the buckets of the bucket roller in order to keep the mixing device free of toner deposits in the bucket roller region, it is then advantageous to interrupt the magnet bars in the region of the toner concentration sensor in all buckets except for one. The result is that a particularly pronounced pulse-shaped spike occurs in the sensor signal when the bucket with the uninterrupted magnet bar passes the toner concentration sensor while the pulse-shaped spikes are less pronounced with the other buckets.

If no pulse-shaped spike should occur during a revolution of the bucket roller, an error exists. In this case, it is appropriate to generate a trigger signal independent of the curve of the sensor signal, which trigger signal controls the measurement window. Such an error case can be detected with an error counter. This is incremented when no pulse-shaped spike occurs during a revolution of the bucket roller, and is decremented when a pulse-shaped spike occurs again in the next revolution. This error counter can be used in an advantageous manner in order to establish whether the mixing device exhibits a continuous error. When the counter state exceeds a predetermined value, this can be assessed as a circumstance that the mixing device operates incorrectly and the printing operation can then be aborted.

In a further embodiment of the invention, a trigger signal for control of the measurement window can be acquired with the aid of a sensor device that is built from a magnet arranged at the shaft of the bucket roller and a fixed Hall sensor. When the magnet passes the Hall sensor, this generates the trigger signal that controls the opening of the measurement window. In order to eliminate manufacturing tolerances, it is appropriate to determine once the temporal interval between trigger signal and occurrence of the next pulse-shaped spike in the sensor signal and, in operation, to open the measurement window when the simulation of the above temporal interval and a predetermined delay period has elapsed. Instead of the sensor device with a Hall sensor, a light barrier or a switching contact can also be used to generate the trigger signal.

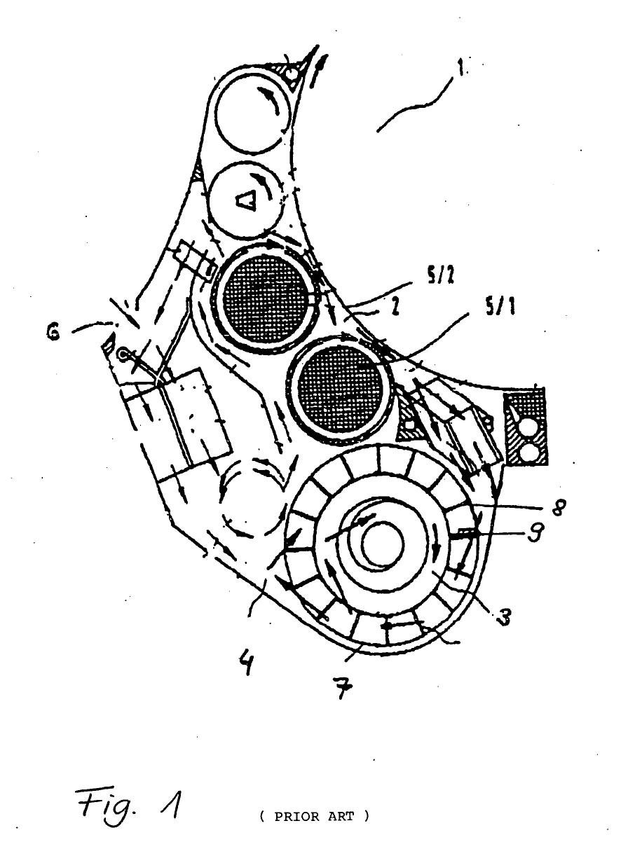

A developer station 2 in which a mixing device 7 is provided with a bucket roller 3 is shown in FIG. 1. The developer mixture is continuously stirred with the aid of the bucket roller 3, which is provided with buckets 8. Magnet bars 9 that should keep the bucket roller region free of toner are arranged on the buckets 8. In FIG. 1, a plurality of buckets are provided; for explanation of the preferred embodiment, it is sufficient that, corresponding to FIG. 5, three buckets 8a, 8b, 8c are used. The magnet bar 9 is uninterrupted on one of the three buckets (for example 8a) while the magnet bars on the other buckets are interrupted (deactivated) when they are in the region of the toner concentration sensor 10. The radial position of the toner concentration sensor 10 results from FIG. 5; it is clear that this is adjacent to the buckets 8 of the bucket roller 3. The toner concentration sensor can be realized as an inductive sensor.

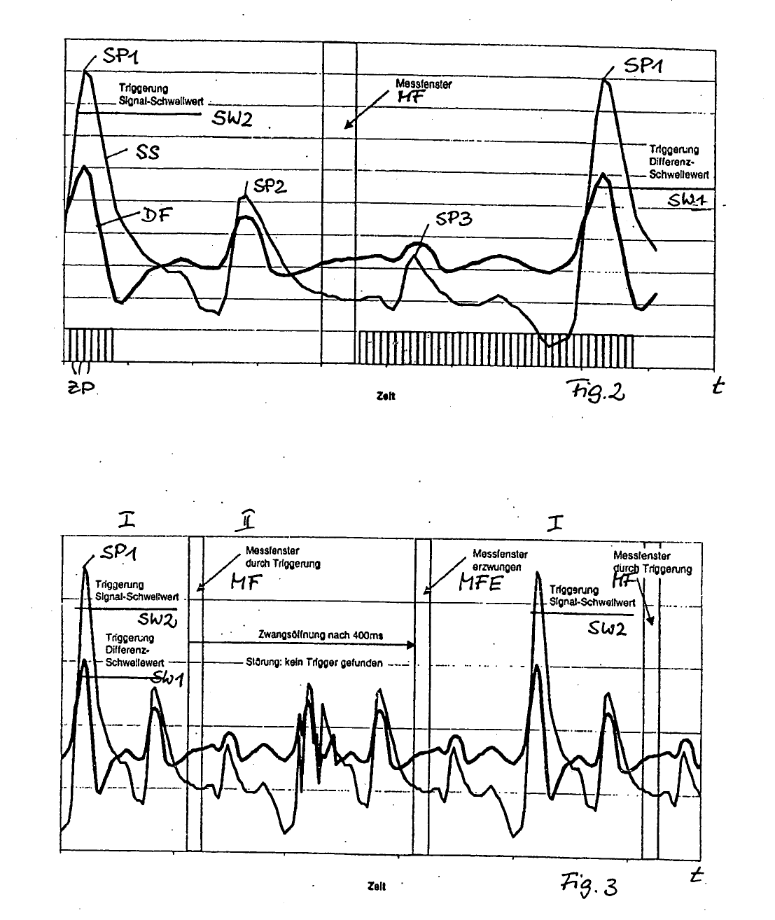

The curve of the sensor signal SS emitted by the toner concentration sensor, plotted over the time t over a rotation of the bucket roller 3, results from FIG. 2. From the curve of the sensor signal SS it is to be learned that this exhibits pulse-shaped spikes SP upon the buckets of the bucket wheel passing by the remote control sensor, however in the remaining region FIG. 2 shows a curve determined by the toner concentration.

In addition to the curve of the sensor signal SS, the curve of the difference values DF is shown plotted over time t. These difference values DF are determined in that the amplitude values of the sensor signal SS are determined at fixed points in time ZP, the amplitude values of successive points in time are subtracted from one another, and the difference values DF are checked as to when they cross a threshold SW1. When this is the case, a trigger signal identifying the temporal position of the pulse-shaped spike can be emitted. However, it is also possible that the trigger signal is emitted when the sensor signal crosses a predetermined threshold SW2 or has reached its peak value. Furthermore, it is possible that the trigger signal is emitted when the difference value DF has reached a maximal value and thus has reached the greatest rise. Or, the trigger signal can be emitted when a*SS+b*DF>SW, where a and b are selectable constants.

The points in time of the sampling of the sensor signal are plotted over time t in FIG. 2; with the interval between the sampling points in time remaining constant. The difference of the amplitude values between two sample points in time is designated with x(n)−x(n−a), where n is the index of the current measurement value, and a is the increment that can be selected, for example with a=5.

From the example of FIG. 2, it can be learned that the sensor signal SS exhibits a pulse-shaped spike SP1 during a rotation of the bucket roller 3, which pulse-shaped spike SP1 is associated with the bucket 8a provided with an uninterrupted magnet bar 9. The remaining two buckets 8b, 8c with magnet rails in the scanning region generate only small pulse-shaped spikes SP2, SP3 that are below the predetermined threshold SW.

As results from the curve of the sensor signal SS, in the above case (in which only one bucket is provided with a magnet rail in the sampling region) a measurement window MF that lies after the bucket 8b following the passage of the bucket 8a generating the trigger signal is advantageous for the measurement of the toner concentration. In particular the sensor signal is then least disturbed by the buckets. The measurement window MF can then be controlled by the trigger signal, whereby it can be opened when a predetermined time has elapsed after occurrence of the trigger signal.

The case that no pulse-shaped spike SP has occurred in the sensor signal SS during a rotation of the bucket roller 3 results from FIG. 3 (shown again is the curve of the sensor signal SS and the curve of the difference values DF plotted over the time t). Initially the case is shown in which the pulse-shaped spike SP1 exists as in the error-free case; subsequently shown is the situation in which a pulse-shaped spike no longer appears (region II). When this situation is given at least during one rotation of the bucket roller, a trigger signal that controls the measurement window MFE is compulsorily generated independently of the curve of the sensor signal. The compulsory triggering is advantageously implemented so that the forced measurement window MFE comes to be situated one rotation later than the measurement window MF.

The occurrence of such error cases can be monitored with the aid of an error counter. Each time when no pulse-shaped spike occurs during a revolution of the bucket roller, the error counter is incremented by a unit; when a pulse-shaped spike subsequently appears again, the error counter is decremented by a unit. If the error counter should exceed a predetermined numerical value, an error signal is generated that indicates that the mixing device operates incorrectly.

A principle representation of a bucket roller 3 with three buckets 8a, 8b, 8c results from FIG. 5. An uninterrupted magnet bar 9 is mounted on one bucket 8a, while the other buckets 8b, 8c comprise an interrupted magnet bar in the region of the toner concentration sensor 10. The rotation direction of the bucket roller is shown by an arrow. A magnet 11 is arranged on the shaft 13 of the bucket roller, outside of the mixing device; a Hall sensor 12 is arrange adjacent to the magnet 11. When the magnet 11 passes by the Hall sensor 12, this generates a trigger signal that can be drawn upon to control the measurement window MF.

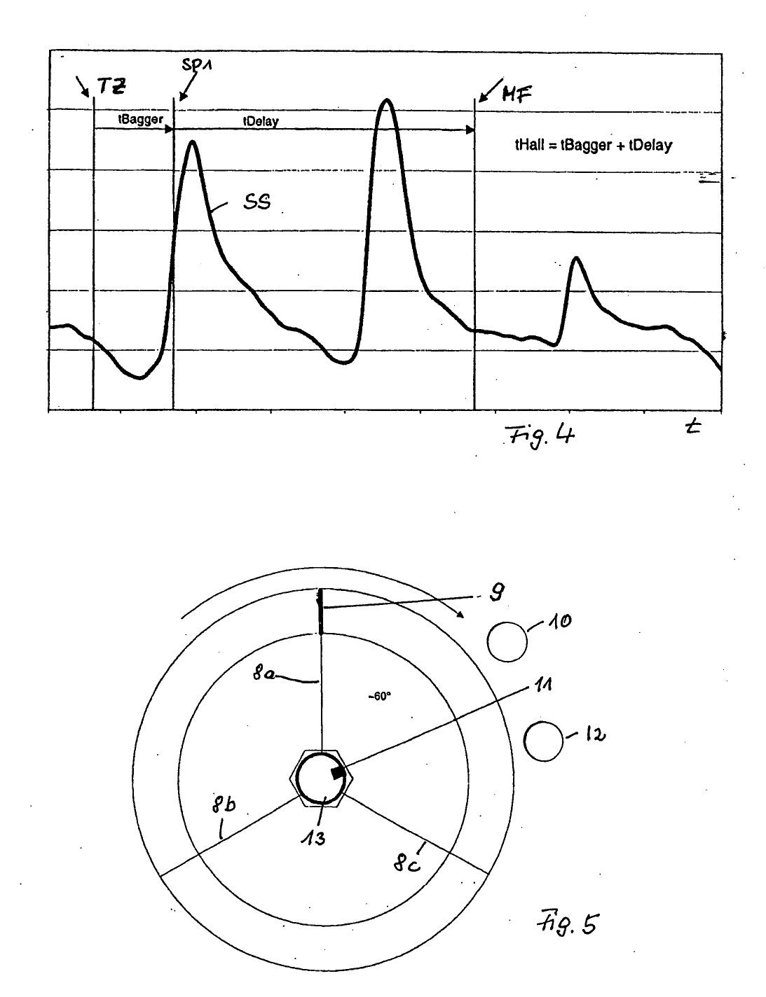

FIG. 4 shows the path of the sensor curve SS given one revolution of the bucket roller 3. The point in time TZ at which the Hall sensor emits the trigger signal is designated. Furthermore, the point in time of the occurrence of the pulse-shaped spike SP1 in the sensor signal is indicated. The measurement window MF is opened, and is calculated from this point in time on, after expiration of a delay time t(Delay) dependent on the rotation speed of the bucket roller. In order to be able to control the point in time of the opening the of the measurement window MF from the trigger signal, the time interval t(Excavator) of the trigger signal (occurrence of the pulse-shaped spike) must be determined. It is therefore appropriate to determine the temporal interval t(Excavator) once for each mixing device. The point in time at which the measurement window is opened can subsequently be determined via addition of the time interval t(Excavator) with the predetermined delay value t(Delay). The temporal position of the pulse-shaped spike SP can be established as explained above.

In contrast to the embodiment according to FIG. 2, in FIG. 4 the pulse-shaped spike SP must only be determined once. The opening of the measurement window MF is subsequently implemented after the time t(Excavator)+t(Delay) since both values no longer change. The opening of the measurement window MF can thus be controlled solely via the trigger signal generated by the Hall sensor. If the Hall sensor should fail, a compulsory triggering can be generated as described above.

The evaluation of the sensor signal or of the difference values can occur according to software and/or with aid of standard electronic components.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

We claim as our invention:

1-20. (canceled)

21. A method for control of a point in time of a measurement of toner concentration in a developer mixture comprising toner and carrier, comprising the steps of:
mixing the developer mixture by a bucket roller provided with buckets situated in a mixing device;
arranging a toner concentration sensor for measurement of the toner concentration in the developer mixture adjacent to the bucket roller;
arranging magnet bars on the buckets of the bucket roller and interrupting the magnet bars when they are in a region adjacent to the toner concentration sensor except for one of the magnet bars which is uninterrupted when it is in the region adjacent to the toner concentration sensor;
with the toner concentration sensor emitting a sensor signal that
upon passage of the bucket with the uninterrupted magnet bar, exhibits a first pulse-shaped spike with a larger amplitude caused by the uninterrupted magnet bar,
exhibits further pulse-shaped spikes of smaller amplitude upon passage of the further buckets with the interrupted magnet bars, and
exhibits a value indicating the toner concentration between the pulse-shaped spikes;
determining a point in time of occurrence of the first pulse-shaped spike in the sensor signal; and
implementing a measurement of the toner concentration in a measurement window that lies after occurrence of the first pulse-shaped spike of the sensor signal in a region of the sensor signal that lies between the spikes caused by the buckets.

22. A method according to claim 21 in which a temporal position of the pulse-shaped spike is indicated when the sensor signal has a largest rise.

23. A method according to claim 22 in which, to record a signal curve of the sensor signal:
successive individual measurements of the sensor signal are implemented at a same time interval,
a difference of successive measurement values acquired via the individual measurements is generated, and
a highest determined difference value indicates a position of the pulse-shaped spike.

24. A method according to claim 23 in which the temporal position of the pulse-shaped spikes is indicated when a curve generated from the difference values exceeds a predetermined threshold.

25. A method according to claim 21 in which a temporal position of the pulse-shaped spikes is indicated when the pulse-shaped spikes of the sensor signal exceed a predetermined threshold or reach a highest value.

26. A method according to claim 25 in which the temporal position of the pulse-shaped spikes is indicated when a combination rise/amplitude exceeds a threshold.

27. A method according to claim 21 in which, upon occurrence of the first pulse-shaped spike, a measurement window is placed after a time period calculated from a temporal position of the first pulse-shaped spike.

28. A method according to claim 21 in which a measurement window is placed such that, after passage of the bucket with the uninterrupted magnet bar, at least one further bucket passes by the toner concentration sensor.

29. A method according to claim 21, in which a measurement window is opened independent of a sensor signal curve for the case that no pulse-shaped spike has occurred in the sensor signal during a rotation of the bucket roller.

30. A method according to claim 29 in which an error counter is incremented when no pulse-shaped spike is determined in the sensor signal during a revolution of the bucket roller, and an error counter is decremented again when a pulse-shaped spike occurs again in a next revolution.

31. A method according to claim 13 in which an error signal is emitted when a counter value of the error counter exceeds a predetermined counter value.

32. A method according to claim 21 in which the mixing device is arranged in a developer station for an electrophotographic printer or copier.

33. A method for control of a point in time of a measurement of toner concentration in a developer mixture comprising toner and carrier, comprising the steps of:
mixing the developer mixture by a bucket roller provided with buckets situated in a mixing device;
with a toner concentration sensor arranged adjacent to the bucket roller emitting a signal indicating the toner concentration in the developer mixture, said sensor signal
exhibiting pulse-shapes spikes upon passage of the buckets, and
exhibiting a value indicating the toner concentration between the pulse-shaped spikes;
arranging a magnet on a shaft of the bucket roller and arranging a Hall sensor adjacent to the magnet and to the bucket roller, the Hall sensor emitting a trigger signal when the magnet passes by the Hall sensor; and
implementing the measurement of the toner concentration controlled by the trigger signal in a measurement window that lies in a region of the sensor signal that lies between the spikes caused by the buckets.

34. A method according to claim 33 in which a time interval between occurrence of the trigger signal and occurrence of a next pulse-shaped spike in the sensor signal is determined once before a beginning of the measurement event, and the measurement occurs when a sum from said time interval and a predetermined delay period has elapsed.

35. A method according to claim 34 in which magnet bars are arranged on the buckets of the bucket roller, and a respective magnet bar is interrupted in each bucket when it is in a region adjacent to the toner concentration sensor, except for one of the bars which is uninterrupted when it is in said region of the sensor; and
in which the toner concentration sensor emits a sensor signal that, upon passage of the bucket with the uninterrupted magnet bar, exhibits a first pulse-shaped spike of larger amplitude that is used to determine the time interval between occurrence of the trigger signal and occurrence of the first pulse-shaped spike.

36. A method according to claim 35 in which a temporal position of the pulse-shaped spike is indicated when the sensor signal has a largest rise.

37. A method according to claim 36 in which, to record a signal curve of the sensor signal,
successive individual measurements of the sensor signal are implemented at a same time interval,
a difference of successive measurement values acquired via the individual measurements is generated, and
a highest determined difference value indicates position of the pulse-shaped spike.

38. A method according to claim 37 in which the temporal position of the pulse-shaped spikes is indicated when a curve generated from the difference values exceeds a predetermined threshold.

39. A method according to claim 33 in which the temporal position of the pulse-shaped spikes is indicated when the pulse-shaped spikes of the sensor signal exceed a predetermined threshold or a highest value.

40. A method according to claim 39 in which the temporal position of the pulse-shaped spikes is indicated when a combination rise/amplitude exceeds a threshold.

41. A method according to claim 33, in which, upon occurrence of a first pulse-shaped spike, a measurement window is placed after a time period calculated from a temporal position of the first pulse-shaped spike.

42. A method according to claim 35 in which a measurement window is placed such that, after passage of the bucket with the uninterrupted magnet bar, at least one further bucket passes by the toner concentration sensor.

43. A method according to claim 33, in which a measurement window is opened independent of a curve of the sensor signal for the case that no pulse-shaped spike has occurred in the sensor signal during a rotation of the bucket roller.

44. A method according to claim 43 in which an error counter is incremented when no pulse-shaped spike is determined in the sensor signal during a revolution of the bucket roller, and an error counter is decremented again when a pulse-shaped spike occurs again in a next revolution.

45. A method according to claim 44 in which an error signal is emitted when a counter value of the error counter exceeds a predetermined counter value.

46. A method according to claim 33 in which the mixing device is arranged in a developer station for an electrophotographic printer or copier.

47. An arrangement for control of a point in time of a measurement of a toner concentration in a developer mixture comprising toner and carrier, comprising:
a bucket roller arranged in a mixing device for the developer mixture, the developer mixture being stirred with buckets of the bucket roller;
a toner concentration sensor arranged adjacent to the bucket roller for measurement of the toner concentration in the developer mixture;
identical bars being provided on buckets of the bucket roller, respective magnetic bars in each bucket being interrupted when they are in a region adjacent to the toner concentration sensor except for one magnetic bar which it is uninterrupted in said region; and
the toner concentration sensor emitting a sensor signal indicating the toner concentration, the sensor signal exhibiting, upon passage of the bucket with the uninterrupted magnet bar, a first pulse-shaped spike from which a measurement window is derived in which the toner concentration is measured.

48. An arrangement for control of a point in time of a measurement of toner concentration in a developer mixture comprising toner and carrier, comprising:
a bucket roller in a mixing device for the developer mixture, buckets of the bucket roller stirring the developer mixture;
a toner concentration sensor that emits a sensor signal dependent on the toner concentration arranged adjacent to the bucket roller, said sensor signal
exhibiting pulse-shaped spikes upon passage of the buckets, and
exhibiting a value indicating the toner concentration between the pulse-shaped spikes;
a magnet arranged on a shaft of the bucket roller and a Hall sensor arranged adjacent to the magnet and to the bucket roller, said Hall sensor emitting a trigger signal when the magnet passes by the Hall sensor; and
the measurement of the toner concentration by the toner concentration sensor occurring controlled by the trigger signal in a measurement window that lies in a region of the sensor signal that lies between the spikes caused by the buckets.

49. An arrangement according to claim 48 further comprising:
magnetic bars arranged on the buckets of the bucket roller, and the respective magnetic bars are interrupted in each bucket when it is in a region adjacent to the toner concentration sensor except for one magnetic bar which is uninterrupted in said region;
the toner concentration sensor emitting a sensor signal that, upon passage of the bucket with the uninterrupted magnet bar exhibits a first pulse-shaped spike; and
the first pulse-shaped spike is determined and a measurement window is established dependent on a time interval between the trigger signal and the occurrence of the first pulse-shaped spike of the sensor signal, delayed by a delay period.

50. An arrangement according to claim 49 in which the magnet and the Hall sensor are arranged outside of a mixing region of the mixing device.

51. An arrangement according to claim 48 which is for a printer or copier.
